(19) United States
(12) Patent Application Publication
(10) Pub. No.: US 2022/0151088 A1
(43) Pub. Date: May 12, 2022

(54) CONTROL BOX ASSEMBLY OF A TANKER TRUCK AND METHOD RELATING THERETO

(71) Applicant: Mac LTT, Inc., Kent, OH (US)

(72) Inventor: James A. Maiorana, Hartville, OH (US)

(73) Assignee: Mac LTT, Inc., Kent, OH (US)

(21) Appl. No.: 17/381,962

(22) Filed: Jul. 21, 2021

Related U.S. Application Data
(60) Provisional application No. 63/110,699, filed on Nov. 6, 2020.

(51) Int. Cl. H05K 5/00; B60P 3/22

(52) U.S. Cl. CPC H05K 5/0026; B60P 3/224

(57) ABSTRACT

A control box assembly of a tanker truck and method relating thereto is provided. The control box assembly may be coupled to a frame of the tanker truck below a tank of the tanker truck. The control box assembly may include a housing, a front wall of the housing, an opening defined by the front wall, and a control panel operably engaged with the housing. The control panel may be positioned within the opening of the front wall and the control panel may be pivotable between a first position and a second position.

### CROSS REFERENCE TO RELATED APPLICATIONS

This application claims the benefit of U.S. Provisional Application Ser. No. 63/110,699, filed on Nov. 6, 2020; the disclosure of which is incorporated herein by reference.

### TECHNICAL FIELD

The present disclosure generally relates to control box assemblies. More particularly, the present disclosure relates to control box assemblies of tanker trucks with improved access. Specifically, the present disclosure relates to control box assemblies of tanker trucks with improved access having a pivotable control panel.

### BACKGROUND

Generally, control box assemblies are utilized to control operations associated with various industries. One exemplary industry is the cargo-carrying truck industry where the cargo-carrying trucks utilize the control box assemblies to control operations associated with loading loads, unloading loads, providing power, and the like. To accomplish this, the control box assembly utilizes various mechanical and electrical connections and components, such as, for example, electrical power sources, pneumatic air hoses, pneumatic pumps, and/or any other necessary mechanical or electrical connections and components. One drawback associated with these types of control box assemblies involves servicing the electrical and mechanical connections or components. As the control box assemblies are typically bolted to the frames of the cargo-carrying trucks, it is very difficult to access the control box assemblies if electrical and/or mechanical connections or components need to be serviced or replaced.

### SUMMARY

In some instances, accessing control box assemblies in order to service electrical and/or mechanical connections and/or components is difficult. The present disclosure addresses these and other issues.

In one aspect, an exemplary embodiment of the present disclosure may provide a control box assembly of a tanker truck, comprising: a frame of the tanker truck; a tank of the tanker truck operably engaged with the frame; a housing; a front wall of the housing; an opening defined by the front wall; and a control panel operably engaged with the housing; wherein the control panel is positioned within the opening of the front wall; wherein the control panel is pivotable between a first position and a second position; and wherein the control box assembly is coupled to the frame of the tanker truck below the tank of the tanker truck. The control box assembly may further include a front of the control box assembly; and a rear surface of the control panel; wherein the rear surface of the control panel is accessible from the front of the control box assembly when the control panel is in the second position. The control box assembly may further include an angle of rotation of the control panel between the first position and the second position of at least approximately thirty degrees. The control box assembly may further include a pivotable portion of the control panel; and a stationary portion of the control panel; wherein the pivotable portion is pivotable between the first position and the second position.

The control box assembly may further include a securing mechanism of the control panel; wherein the securing mechanism releasably secures the control panel to the housing in the first position. The control box assembly may further include a pivot mechanism operably engaged with the housing and the control panel; and a pivot axis defined by the pivot mechanism; wherein the control panel is pivotable about the pivot axis; and wherein the pivot mechanism is positioned entirely within the housing. In some implementations, the pivot axis is substantially horizontal. In other implementations, the pivot axis is substantially vertical. The control box assembly may be configured to control one or more tank operations of the tanker truck. When the control box assembly is operably engaged with the tanker truck, the rear surface of the control panel is still accessible from the front of the control box assembly when the control panel is in the second position. The control box assembly may further include an access door operably engaged with the housing configured to provide access to the control panel.

In another aspect, an exemplary embodiment of the present disclosure may provide a method for accessing a control box assembly. The method includes coupling the control box assembly to a frame of the tanker truck below a tank of the tanker truck and pivoting a control panel of the control box assembly from a first position to a second position. The method may further include providing access to a rear surface of the control panel from a front of the control box assembly when the control panel is in the second position. The method may further include pivoting the control panel from the first position to the second position through an angle of rotation of at least approximately thirty degrees. The method may include pivoting a pivotable portion of the control panel from the first position to the second position. The method may include securing, via a securing mechanism of the control panel, the control panel to a housing of the control box assembly. The method may include pivoting the control panel about a pivot axis defined by a pivot mechanism. In some implementations, the pivot mechanism is positioned entirely within a housing of the control box assembly. In some implementations, the method may include positioning the pivot mechanism such that the pivot axis is substantially horizontal. In other implementations, the method may include positioning the pivot mechanism such that the pivot axis is substantially vertical.

The method may further include positioning the control panel in the second position such that the rear surface of the control panel is substantially parallel to a top wall of a housing of the control box assembly. The method may further include controlling, via the control box assembly, one or more tank operations of the tanker truck. The method may further include servicing (e.g., inspecting, repairing, etc.) the control panel and/or any components associated with the control panel, when the control panel is in the second position.

In another aspect, and exemplary embodiment of the present disclosure may provide a control box assembly and method relating thereto. The control box assembly may be coupled to a frame of the tanker truck below a tank of the tanker truck. The control box assembly may include a housing, a front wall of the housing, an opening defined by the front wall, and a control panel operably engaged with the housing. The control panel may be positioned within the opening of the front wall and the control panel may be pivotable between a first position and a second position. A method for accessing a control box assembly may include coupling the control box assembly to a frame of the tanker truck below a tank of the tanker truck, pivoting a control panel of the control box assembly from a first position to a second position, and providing access to a rear surface of the control panel from a front of the control box assembly when the control panel is in the second position.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is an environmental view of a tanker truck including a support structure;

FIG. 2 is a partial isometric perspective view of a first embodiment of a control box assembly in accordance with one aspect of the present disclosure;

FIG. 3 is a front view of the first embodiment of the control box assembly;

FIG. 4 is a cross-section view taken along line 4-4 of FIG. 3;

FIG. 5A is a is a cross-section view taken along line 5A-5A of FIG. 4;

FIG. 5B is an operational view of FIG. 5A;

FIG. 6 is an operational view of the first embodiment of the control box assembly;

FIG. 7 is a front view of a second embodiment of a control box assembly in accordance with one aspect of the present disclosure; and

FIG. 8 is a flowchart depicting an exemplary method in accordance with one aspect of the present disclosure.

Similar numbers refer to similar parts throughout the drawings.

### DETAILED DESCRIPTION

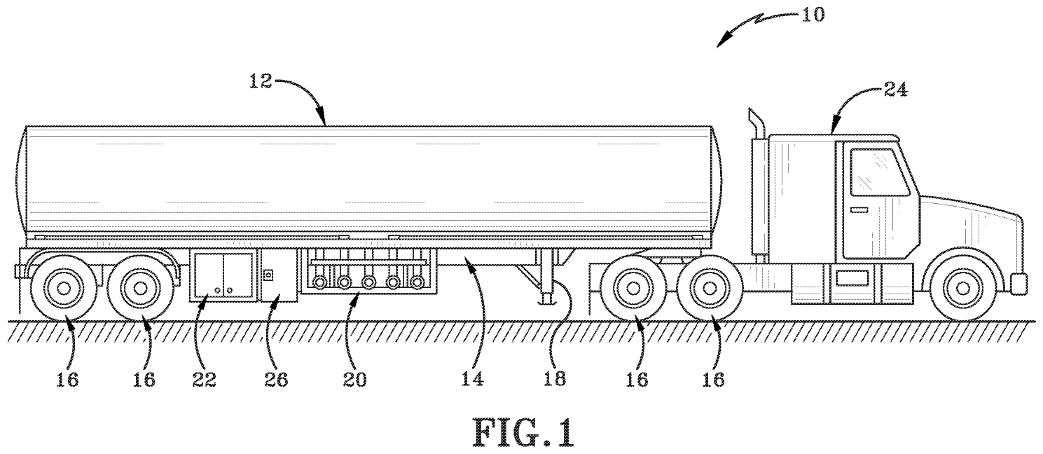

With reference to FIG. 1, a tanker truck is shown generally at 10. The tanker truck 10 may be of a usual construction and may include an elongated, generally cylindrical tank 12 supported by a frame 14. Frame may be carried by one or more pairs of wheel assemblies 16. Tanker truck 10 may include components such as landing gear 18, a nozzle assembly 20, and a support structure 22, such as a storage cabinet, for supporting a control box assembly (not shown in FIG. 1). The support structure 22 may be provided on a side of the frame 14 or in any other suitable location. The particular shape of the tank 12 will be dependent upon the particular load to be transported within a hollow interior (not shown) of the tank 12. Hoses may be selectively engaged with the nozzle assembly 20 to transfer the contents of the tanker truck 10 to another location, such as, for example, a storage tank (not shown). A tractor or cab 24 may be operably engaged with the tank 12 and the frame 14 to provide a pulling force for moving the tanker truck 10.

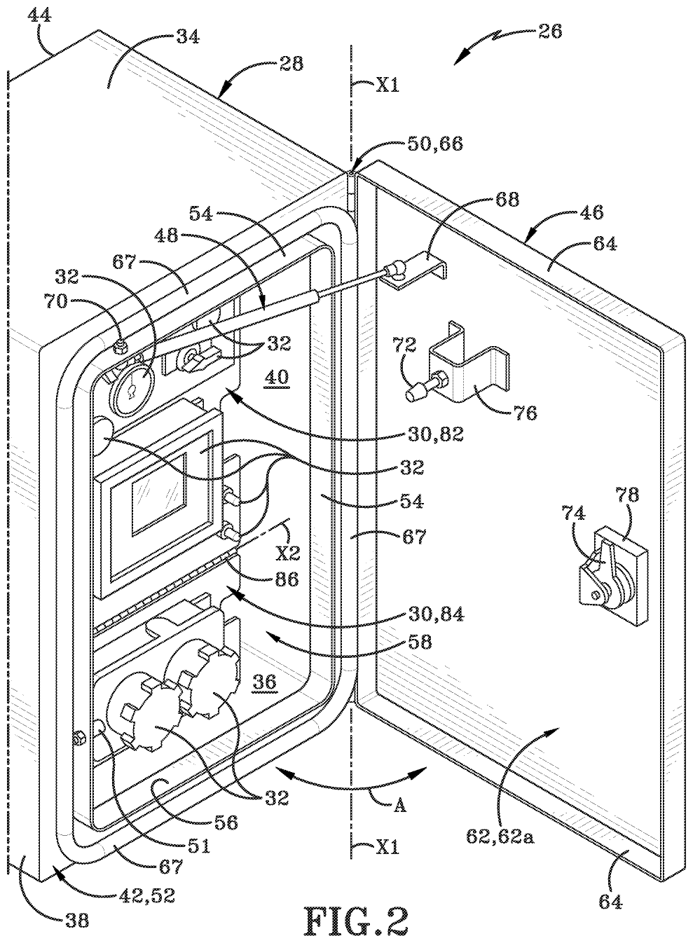

With reference to FIG. 2 through FIG. 6, there is shown a first embodiment of a control box assembly of a tanker truck in accordance with one aspect of the present disclosure generally indicated at 26. Control box assembly 26 may be supported within the support structure 22 provided on the side of the frame 14. Control box assembly 26 may include a housing 28, a control panel 30, and various control, monitoring, electrical and/or mechanical components, which are generally indicated at 32 and are further described below.

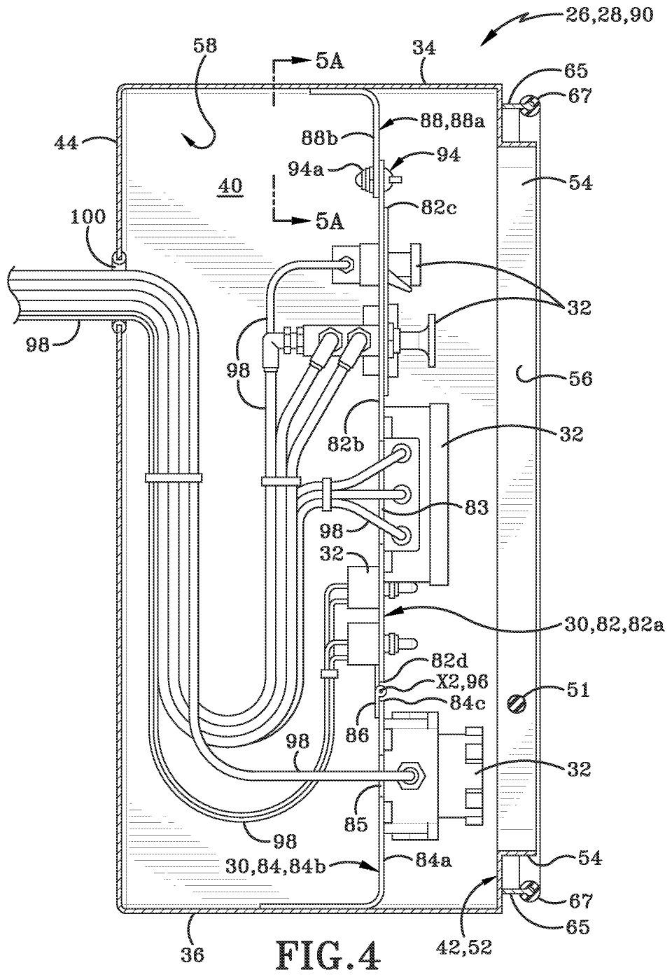

With continued reference to FIG. 2 through FIG. 6, and in some implementations, the housing 28 may be a substantially hollow and generally rectangular structure. The housing 28 may include a top wall 34 and a bottom wall 36 (FIG. 4) defining a vertical direction therebetween, a first sidewall 38 and a second sidewall 40 defining a longitudinal direction therebetween, and a front wall 42 and a rear wall 44 defining a transverse direction therebetween. The housing 28 may further include an access door 46, a closing mechanism 48, an access door pivot mechanism 50, and a support mechanism 51.

With particular reference to FIG. 2, the front wall 42 may include an outer wall portion 52 and an inner wall portion 54. The outer wall portion 52 may be a generally flat surface and may bound the inner wall portion 54. As shown in FIG. 2, the inner wall portion 54 may extend a distance away from the outer wall portion 52 in a transverse direction and may define a generally rounded-rectangular opening 56 for providing access to an interior region 58 (FIG. 4) of the housing 28.

With continued reference to FIG. 2, the access door 46 may be a generally rectangular structure and may be sized to provide ingress and egress to the interior region 58 of the housing 28 as more fully explained herein. The access door 46 may include an exterior wall 62 and a peripheral wall 64 aligned perpendicular to the exterior wall 62. The exterior wall 62 may include an interior surface 62a. The access door 46 may be operably engaged with the housing 28 via the access door pivot mechanism 50. In some implementations, the access door pivot mechanism 50 is a hinge, and, as such, the access door pivot mechanism 50 will be referred to as hinge 50 in the present disclosure. More particularly, the hinge 50 may pivotably connect the housing 28 and the access door 46. The hinge 50 may include a pivot pin 66 that defines an access door pivot axis X1 (FIG. 4). The access door 46 is pivotable about the access door pivot axis X1 in a direction indicated by arrow A. The access door 46 may open and close to provide and restrict access to the interior region 58 of the housing 28. Although the access door pivot mechanism 50 has been described as being a hinge, it is to be understood that the access door 46 pivot mechanism 50 may be any suitable pivot mechanism. The housing 28 may further include a flange 65 and a seal 67 (FIG. 2), such as a gasket, that contacts the interior surface 62a of the access door 46 to seal any gaps between the access door 46 and the housing 28.

The closing mechanism 48, such as a pneumatic door closer, may be coupled with the interior surface 62a of the access door via a bracket 68 and may be coupled with the inner wall portion 54 of the front wall 42 of the housing 28 via a fastener 70, such as a nut and bolt. The closing mechanism is configured to assist in opening and closing the access door 46.

The access door 46 may further include a stopping mechanism 72 and an access door locking mechanism 74. The stopping mechanism 72, such as a bump stop, may be coupled with the interior surface 62a of the access door 46 via a mount 76. The stopping mechanism 72 is configured to prevent damage to the control panel 30. The locking mechanism 74, such as a latch assembly, may be coupled with the interior surface 62a of the access door 46 via a latch mount 78. The locking mechanism 74 may be configurable between a locked and an unlocked position to allow the access door 46 to be securely closed and opened.

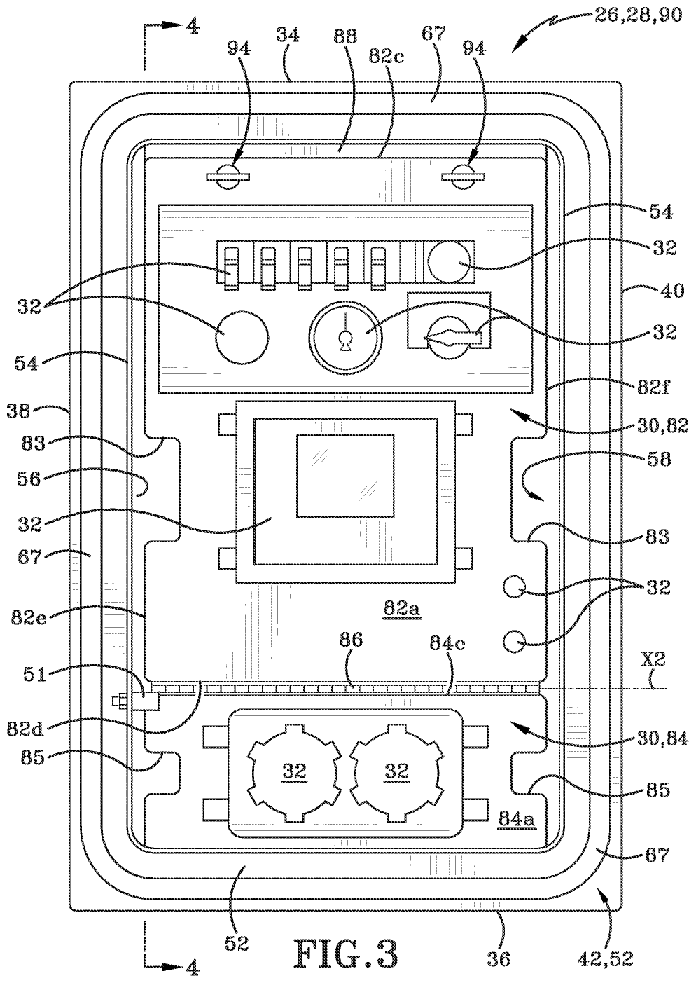

With particular reference to FIG. 3, the support mechanism 51 may be coupled to the housing 28 via any suitable connection, such as a nut and bolt fastener. More particularly, the support mechanism 51, which may be a cylindrical member, maybe coupled to the inner wall portion 54 of the front wall 42 below the panel hinge 86. The support mechanism may be configured to provide support as further described below.

With particular reference to FIG. 3 and FIG. 4, the control panel 30 may include a pivotable portion 82, a stationary portion 84, a control panel pivot mechanism 86, and a top bracket 88. The pivotable portion 82 may include a front surface 82a, a rear surface 82b, a top edge 82c, a bottom edge 82d, a first side edge 82e, and a second side edge 82f. Notches 83 (FIG. 3) may be formed in the side edges 82e and 82f of the pivotable portion 82. The pivotable portion 82 may be movable between a first position 90 and a second position 92 as further described below. The stationary portion 84 may include a front surface 84a, a rear surface 84b, and a top edge 84c. Notches 85 may be formed in the side edges of the stationary portion 84. The top bracket 88 may include a front surface 88a and a rear surface 88b.

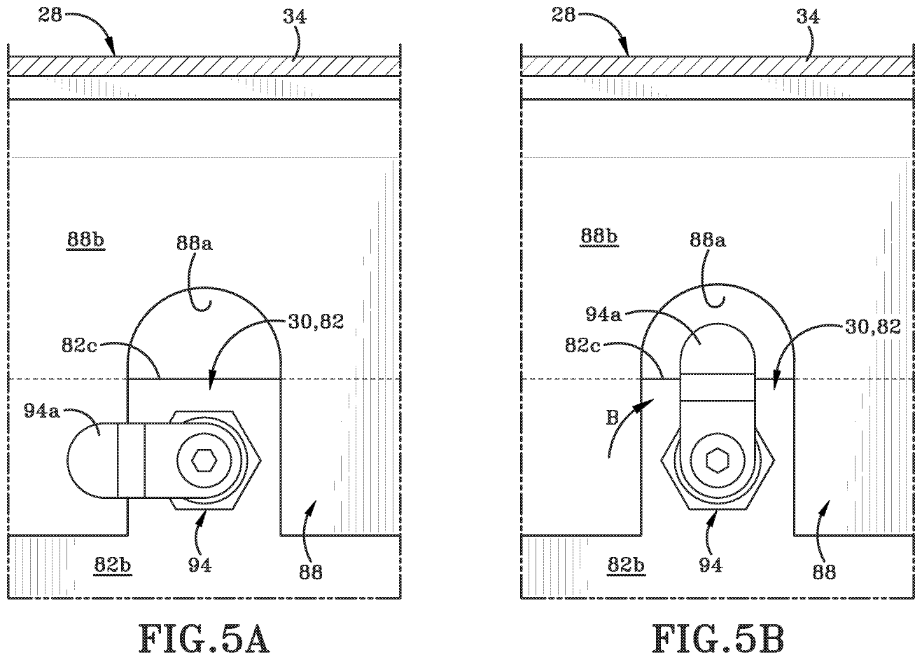

The control panel 30 may be positioned within the interior region 58 of the housing 28. More particularly, the top bracket 88, such as a ninety-degree bracket, may be coupled on one end to the top wall 34 of the housing 28 and may be releasably coupled to the rear surface 82b of the pivotable portion 82 via a securing mechanism 94. In some implementations, the securing mechanism 94 utilizes a pair of locking tabs 94a extending through apertures defined in the top bracket 88. The locking tabs 94a may be configurable between a locked position (FIG. 5A) and an unlocked position (FIG. 5B) to provide a releasably secure connection between the pivotable portion 82 of the control panel 30 and the top bracket 88.

The pivotable portion 82 may be operably engaged with the stationary portion 84 via the control panel pivot mechanism 86. In some implementations, the control panel pivot mechanism 86 is a hinge, and, as such, the control panel pivot mechanism 86 will be referred to as panel hinge 86 in the present disclosure. More particularly, and as shown in FIG. 4, the panel hinge 86 may be operably engaged with the rear surface 82b of the pivotable portion 82 and the rear surface 84b of the stationary portion 84. The panel hinge 86 may include a panel pivot pin 96 that defines a control panel pivot axis X2 (FIG. 3). In some implementations, the control panel pivot axis X2 is substantially horizontal, however, the control panel pivot axis X2 may take on any suitable orientation. The pivotable portion 82 may be pivotable about the control panel pivot axis X2 to provide and restrict access to the interior region 58 of the housing and the rear surface 82b of the pivotable portion 82, as well as provide and restrict access to the various control, monitoring, electrical and/or mechanical components 32 as further described below.

With continued reference to FIG. 2 through FIG. 6, the control panel 30 may support and display the control, monitoring, electrical and/or mechanical components 32. For example, the control, monitoring, electrical and/or mechanical components 32 may be held within mounting holes (not shown) of the control panel 30. Transmission media 98 (e.g., hoses, cables, electrical wires) may be coupled to the control, monitoring, electrical and/or mechanical components 32. The transmission media 98 may be routed through an aperture 100 defined by the rear wall 44 of the housing 28, the notches 83 of the pivotable portion 82, and the notches 85 of the stationary portion 84 to be coupled with their respective control, monitoring, electrical and/or mechanical systems. In some implementations, the control, monitoring, electrical and/or mechanical components 32 and the transmission media 98 may be associated with air distribution systems, overfill protection systems, and monitoring systems. However, the control, monitoring, electrical and/or mechanical components 32 and the transmission media 98 may be associated with any suitable systems.

Having thus described the structure of the control box assembly 26, and its associated components, primary reference is now made to FIG. 1 through FIG. 6 to depict one exemplary use and operation of the control box assembly 26. In this implementation, the control box assembly 26 will be described as being operably engaged with a tanker truck 10, however, the control box assembly 26 may be utilized with any suitable supporting structure.

With primary reference to FIG. 1, the control box assembly 26 may be supported (e.g., enclosed) within the support structure 22, such as a storage cabinet. The various control, monitoring, electrical and/or mechanical components 32, and the transmission media 98, associated with the tanker truck 10 may be supported and displayed by the control panel 30 and operably coupled with each respective system (e.g., air distribution systems, overfill protection systems, and monitoring system). In the event the control, monitoring, electrical and/or mechanical components 32 and/or the transmission media 98 need to be serviced (e.g., inspected, repaired, etc.), the pivotable portion 82 of the control panel 30 may be pivoted from the first position 90 to the second position 92 to allow easy access to the interior region 58 of the housing 28 and to the rear surface 82b of the pivotable portion 82 as further explained below.

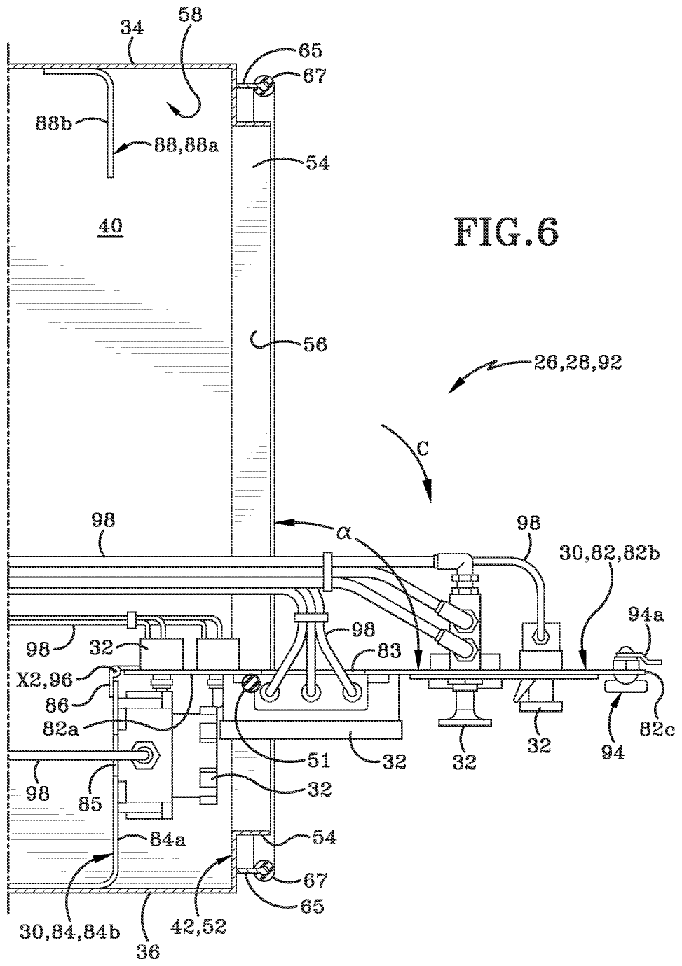

With primary reference to FIG. 3, the pivotable portion 82 of the control panel 30 may be releasably secured to the top bracket 88 via the locking tabs 94a of the securing mechanism 94. To pivot the pivotable portion 82 of the control panel 30 about the control panel pivot axis X2, the locking tabs 94a may be manipulated from the locked position (FIG. 5A) where the locking tab 94a is engaged with the rear surface 88b of the top bracket 88 to the unlocked position (FIG. 5B) by moving the locking tabs 94a in the direction indicated by arrow B (FIG. 56). After the locking tabs 94a have been moved to the unlocked position (FIG. 56), the pivotable portion 82 of the control panel 30 may pivot about the control panel pivot axis X2 in a direction indicated by arrow C (FIG. 6) from the first position 90 to the second position 92. The pivotable portion 82 of the control panel 30 may be supported by the support mechanism 51.

As shown in FIG. 6, the pivotable portion 82 of the control panel 30 may be rotated through an angle of rotation a of approximately ninety degrees such that the pivotable portion 82 of the control panel 30 is substantially parallel with the top wall 34 of the housing 28. Although a particular angle of rotation a has been described, it is to be understood that the angle of rotation may be any suitable angle of rotation to allow access to the interior region 58 of the housing and the rear surface 82b of the pivotable portion 82, such as, for example, an angle of rotation a of at least approximately thirty degrees.

After the control, monitoring, electrical and/or mechanical components 32 and/or the transmission media 98 have been servicing (e.g., inspecting, repairing, etc.), the pivotable portion 82 of the control panel 30 may be pivoted from the second position 92 to the first position 90 to be releasably secured to the top bracket 88.

As stated above, the pivotable movement of the pivotable portion 82 of the control panel 30 is advantageous compared to conventional control box assemblies as it allows easy access to the interior region 58 of the housing 28 and the rear surface 82b of the pivotable portion 82 from a front of the control box assembly 26 even if the control box assembly 26 is operably engaged with a supporting structure, such as the tanker truck 10.

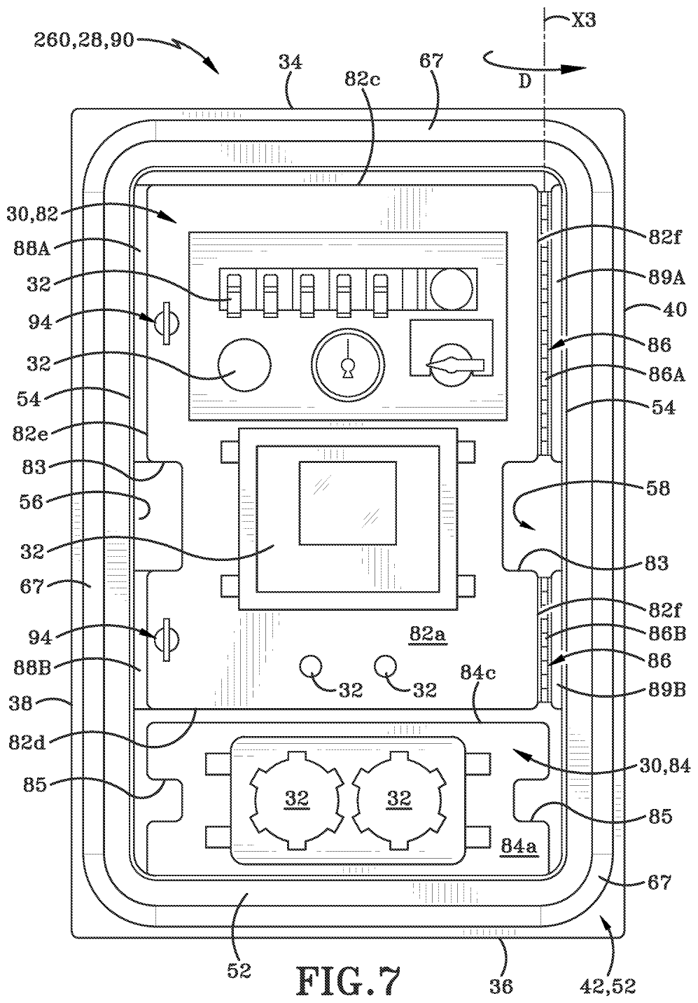

With reference to FIG. 7, there is shown a second embodiment of a control box assembly in accordance with one aspect of the present disclosure generally indicated at 260. The control box assembly 260 is substantially identical to the control box assembly 26 of FIG. 2 through FIG. 6 in structure and function with a few exceptions/additions that will be discussed hereafter in greater detail. Instead of the pivotable portion 82 being operably engaged with the stationary portion 84 via the control panel pivot mechanism 86, the pivotable portion 82 may be operably engaged with the housing 28 via a first control panel pivot mechanism 86A and a second control panel pivot mechanism 86B, which may also be referred to as first panel hinge 86A and second panel hinge 86B respectively, a first bracket 88A, a second bracket 88B, a third bracket 89A, and a fourth bracket 89B. More particularly, the first bracket 88A and the second bracket 88B may be mounted to the first sidewall 38 of the housing while the third bracket 89A and the fourth bracket 89D may be mounted to the second sidewall 40 of the housing 28. The first bracket 88A and the second bracket 88B may be releasably coupled to the rear surface 82b of the pivotable portion 82 via the securing mechanism 94. The pivotable portion 82 may be operably engaged with the housing 28 via the first panel hinge 86A, the second panel hinge 86B, the third bracket 89A and the fourth bracket 89B. The first panel hinge 86A and the second panel hinge 86B may define a control panel pivot axis X3 (FIG. 7). The pivotable portion 82 may be pivotable about the control panel pivot axis X3 to provide and restrict access to the interior region 58 of the housing and the rear surface 82b of the pivotable portion 82, as well as provide and restrict access to the various control, monitoring, electrical and/or mechanical components 32.

The operation of the second embodiment of the control box assembly 260 is substantially identical to the operation of the first embodiment of the control box assembly 26 except that the pivotable portion 82 of the control panel 30 may pivot about the control panel pivot axis X3 in a direction indicated by arrow D (FIG. 7) from the first position 90 to a second position (not shown). As the pivotable portion 82 of the control panel 30 is substantially vertically aligned, there is no need for the support mechanism 51 in this embodiment, however, the pivotable portion 82 may be releasably secured to the housing 28 when in the second position 92 in any suitable manner.

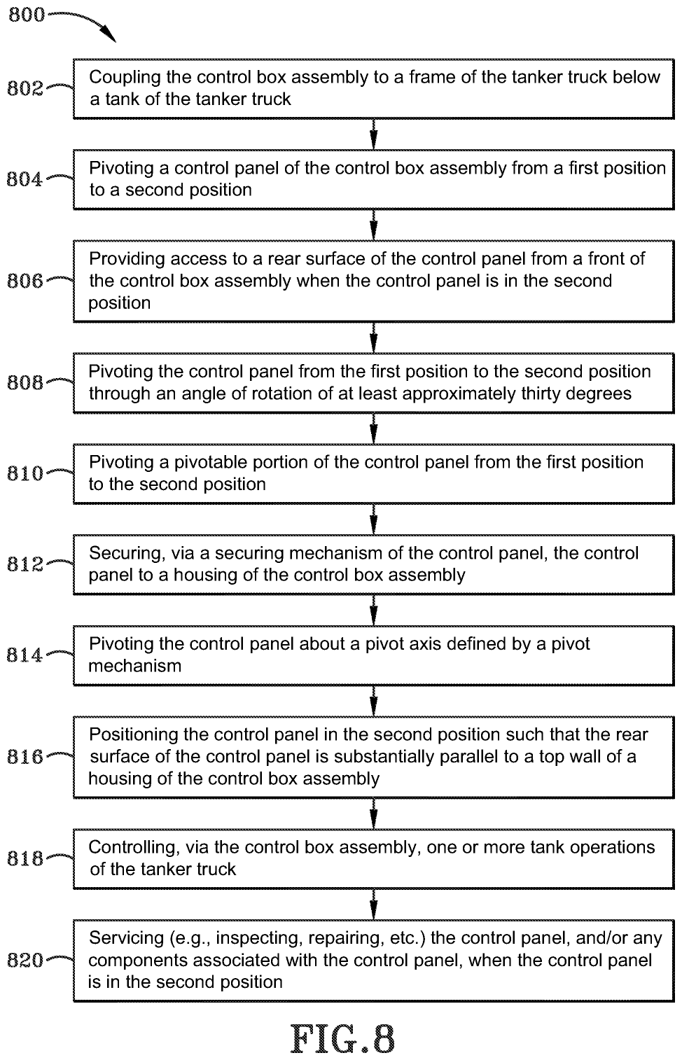

FIG. 8 depicts a method for accessing a control box assembly generally at 800. The method 800 includes coupling the control box assembly to a frame of the tanker truck below a tank of the tanker truck, which is shown generally at 802. The method 800 may further include pivoting a control panel of the control box assembly from a first position to a second position, which is shown generally at 804. The method 800 may further include providing access to a rear surface of the control panel from a front of the control box assembly when the control panel is in the second position, which is shown generally at 806. The method 800 may further include pivoting the control panel from the first position to the second position through an angle of rotation of at least approximately thirty degrees, which is shown generally at 808. The method 800 may include pivoting a pivotable portion of the control panel from the first position to the second position, which is shown generally at 810. The method 800 may include securing, via a securing mechanism of the control panel, the control panel to a housing of the control box assembly, which is shown generally at 812. The method 800 may include pivoting the control panel about a pivot axis defined by a pivot mechanism, which is shown generally at 814. In some implementations, the pivot mechanism is positioned entirely within a housing of the control box assembly. In some implementations, the pivot axis may be substantially horizontal. In other implementations, the pivot axis may be substantially vertical. The method 800 may further include positioning the control panel in the second position such that the rear surface of the control panel is substantially parallel to a top wall of a housing of the control box assembly, which is shown generally at 816. The method 800 may further include controlling, via the control box assembly, one or more tank operations of the tanker truck, which is shown generally at 818. The method 800 may further include servicing (e.g., inspecting, repairing, etc.) the control panel, and/or any components associated with the control panel, when the control panel is in the second position, which is shown generally at 820.

Although the control panel 30 has been described as having a pivotable portion 82 and a stationary portion 84, it is to be understood that any portion of the control panel 30 (including the entire control panel 30) may be pivotable. Further, it is to be understood that the various components of the control box assembly 26 may be coupled together, or operably engaged, in any suitable manner, such as, for example, welded connections. Still further, it is to be understood that the teachings of the present disclosure may be adapted to other configurations of control box assemblies, such as, for example, a horizontally-aligned control box assembly as opposed to a vertically aligned control box assembly as presented herein.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A control box assembly of a tanker truck, comprising:
a frame of the tanker truck;
a tank of the tanker truck operably engaged with the frame;
a housing of the control box assembly;
a front wall of the housing;
an opening defined by the front wall; and
a control panel of the control box assembly operably engaged with the housing;
wherein the control panel is positioned within the opening of the front wall; wherein the control panel is pivotable between a first position and a second position; and wherein the control box assembly is coupled to the frame of the tanker truck below the tank of the tanker truck.

2. The control box assembly of claim 1, further comprising:
a front of the control box assembly; and
a rear surface of the control panel; wherein the rear surface of the control panel is accessible from the front of the control box assembly when the control panel is in the second position.

3. The control box assembly of claim 1, further comprising:
an angle of rotation of the control panel between the first position and the second position of at least approximately thirty degrees.

4. The control box assembly of claim 1, further comprising:
a pivotable portion of the control panel; and
a stationary portion of the control panel; wherein the pivotable portion is pivotable between the first position and the second position.

5. The control box assembly of claim 1, further comprising:
a securing mechanism of the control panel; wherein the securing mechanism releasably secures the control panel to the housing in the first position.

6. The control box assembly of claim 1, further comprising:
a pivot mechanism of the control box assembly; wherein the pivot mechanism is operably engaged with the housing and the control panel; and
a pivot axis defined by the pivot mechanism; wherein the control panel is pivotable about the pivot axis; and wherein the pivot mechanism is positioned entirely within the housing.

7. The control box assembly of claim 6, wherein the pivot axis is substantially horizontal.

8. The control box assembly of claim 6, wherein the pivot axis is substantially vertical.

9. The control box assembly of claim 1, wherein the control box assembly is configured to control one or more tank operations of the tanker truck.

10. The control box assembly of claim 1, further comprising:
an access door of the control box assembly operably engaged with the housing configured to provide access to the control panel.

11. A method for accessing a control box assembly of a tanker truck, comprising:
coupling the control box assembly to a frame of the tanker truck below a tank of the tanker truck;
pivoting a control panel of the control box assembly from a first position to a second position; and
providing access to a rear surface of the control panel from a front of the control box assembly when the control panel is in the second position.

12. The method of claim 11, further comprising:
pivoting the control panel from the first position to the second position through an angle of rotation of at least approximately thirty degrees.

13. The method of claim 11, further comprising:
pivoting a pivotable portion of the control panel from the first position to the second position.

14. The method of claim 11, further comprising:
securing, via a securing mechanism of the control panel, the control panel to a housing of the control box assembly.

15. The method of claim 11, further comprising:
pivoting the control panel about a pivot axis defined by a pivot mechanism;
wherein the pivot mechanism is positioned entirely within a housing of the control box assembly.

16. The method of claim 15, further comprising:
positioning the pivot mechanism such that the pivot axis is substantially horizontal.

17. The method of claim 15, further comprising:
positioning the pivot mechanism such that the pivot axis is substantially vertical.

18. The method of claim 11, further comprising:
positioning the control panel in the second position such that the rear surface of the control panel is substantially parallel to a top wall of a housing of the control box assembly.

19. The method of claim 11, further comprising:
controlling, via the control box assembly, one or more tank operations of the tanker truck.

20. The method of claim 11, further comprising:
servicing the control panel when the control panel is in the second position.
